(19) United States
(12) Patent Application Publication
(10) Pub. No.: US 2004/0033058 A1
(43) Pub. Date: Feb. 19, 2004

(54) Recording device that stores buffered digital signals to memory flashcards

(76) Inventor: Sid Reich, Ocean, NJ (US)

Correspondence Address: KAPLAN & GILMAN , L.L.P., 900 ROUTE 9 NORTH, WOODBRIDGE, NJ, 07095, US

(21) Appl. No.: 10/640,137

(22) Filed: Aug. 13, 2003

Related U.S. Application Data
(60) Provisional application No. 60/403,553, filed on Aug. 14, 2002.
(60) Provisional application No. 60/409,236, filed on Sep. 9, 2002.
(60) Provisional application No. 60/461,674, filed on Apr. 10, 2003.
(60) Provisional application No. 60/474,269, filed on May 29, 2003.

(51) Int. Cl. H04N 5/76; H04N 5/225

(52) U.S. Cl. 386/111; 386/117

(57) ABSTRACT

A system, method and device for capturing unrecorded images and sounds in memory such that said images and sounds may be saved and played back

This application claims the benefit of the filing date of each of United States provisional patent applications No. 60/403,553, filed Aug. 14, 2002; No. 60/409,236, filed Sep. 4, 2002; No. 60/461,674, filed Apr. 10, 2003; and No. 60/474,269, filed May 29, 2003, the entirety of each of which is incorporated herein by reference.

### TECHNICAL FIELD

This invention relates to cameras, and more particularly, to camera-related devices, systems and methods for capturing unrecorded images and sounds in memory such that said images and sounds may be saved and played back.

### BACKGROUND OF THE INVENTION

Today's society has become increasingly video-oriented. Video equipment finds numerous applications in security, law enforcement, legal proceedings, news reporting, scientific studies, entertainment, family videos and the like. Despite the ubiquity of video equipment, there are often instances when an event occurs that is not captured by video simply because the equipment was not set up in the right position, was not ready to record or simply was not present Many priceless opportunities to record important or interesting events are thus missed and never to be seen on video.

Digital webcam devices employ flash card technology to store short video clips with audio. Typically such devices are capable of storing five to ten such clips depending on their size. However, such devices only store images and sounds of events as they occur.

Video playback devices such as TiVo® permit users to replay images already viewed and continue to view a televised program in a time-delayed mode. This type of device employs a hard disk method of buffering a digital video signal. However, such a system does not permit recapture of images of live events that have already occurred that were not originally recorded.

Accordingly, there exists a need in the art for a device that records events before a decision to record is made.

### SUMMARY OF THE INVENTION

The above and other problems of the prior art are overcome in accordance with the present invention which relates to a device, system and method that monitors images and sounds and permits capture of unrecorded events for a particular period of time, such as the last 0-30 seconds or more “seen” by the camera, and is able to record that video to a removable media.

In one embodiment the device automatically switches from a monitoring mode, wherein the last 30 seconds or so “seen” by the camera can be and is captured to memory, to a direct real time record mode if no further action is taken by the user, e.g., the “stop” button is pressed. In a preferred embodiment the device is adaptable to be attached to headgear such as but not limited to a pair of glasses or the bill of a cap and transmits the video to a remote device such as a hip pack where the video is recorded. In a preferred embodiment an LCD screen is incorporated in the remote device and continuous recording capability to a compact flash card is provided.

In a preferred embodiment a digital camera is employed and a wireless connection is provided.

### BRIEF DESCRIPTION OF THE DRAWINGS

FIG. 1 is block diagram depicting the components of a preferred embodiment according to the present invention.

FIG. 2 is a block diagram depicting a preferred embodiment of the steps and information flow performed in accordance with the present invention.

FIG. 3 is a block diagram of a preferred embodiment of an algorithm performed by software in accordance with the teachings of the present invention.

FIG. 4 is a block diagram of a most preferred embodiment of an algorithm performed by software in accordance with the teachings of the present invention.

FIG. 5 is a front perspective view of a preferred embodiment of a device according to the present invention.

FIG. 6 is a front perspective view of a most preferred embodiment of a device according to the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in one embodiment” in various places in the specification are not necessarily all referring to the same embodiment.

In accordance with the invention, images and audio that are monitored yet unrecorded are captured and capable of being played back. In one embodiment a device according to the present invention monitors images and sounds and captures the last 30 seconds of what was monitored by the camera to a removable media when requested by user.

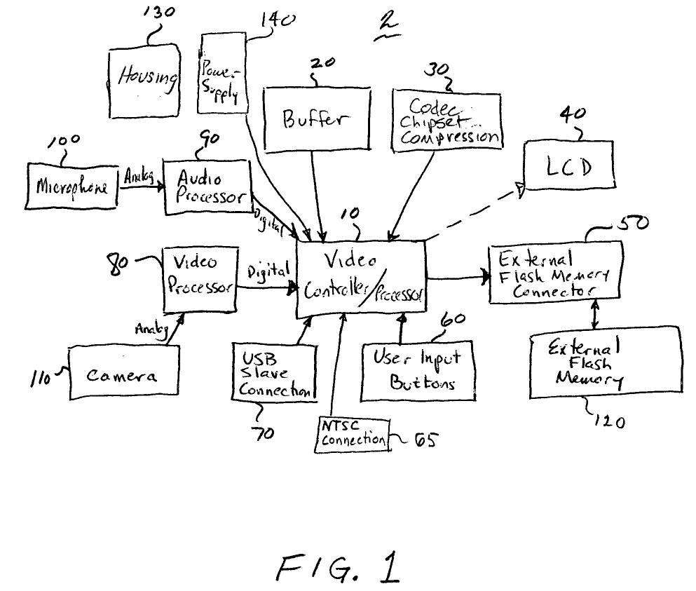

Now referring to FIG. 1 in one embodiment a device 2 according to the invention may comprise video controller/processor 10, buffer 20, codec chipset compression 30, LCD 40, external flash memory connector 50, user input buttons 60, NTSC connection 65, USB slave connection 70, video processor 80, audio processor 90, microphone 100, camera 110, external flash memory 120, housing 130 and power supply 140.

Buffer 20 may comprise DRAM but preferably comprises SDRAM or other suitable memory devices known to those skilled in the art. Codec 30 preferably comprises MPEG 4 but may comprise other compression means known to those skilled in the art. A USB connection 70 is preferably included to allow the device 2 to write to a PC. NTSC connection 65 is provided to permit connection of the device 2 to devices such as televisions, VCRs, DVD burners and the like. Power supply 140 supplies power to device 2 and is preferably in the form of a rechargeable battery such as may be recharged using a standard 110 recharging connection known to those skilled in the art Power supply 140 preferably sustains 8 hours of operations with a maximum of 250 video captures.

In general camera 110 receives images and transmits analog signals to video processor 80 that converts the analog signals to digital signals. Camera 110 may be a CCD camera. The digital signals are transmitted to video controller/processor 10 and sent to external flash memory 120 via connector 50. Microphone 100 receives analog audio signals and transmits same to audio processor 90 that converts the signals to digital for transmission to controller 10. The digital audio and video signals are sent to buffer 20 compressed in codec 30 and subsequently sent to external flash memory 120. The components are standard components known to those skilled in the art.

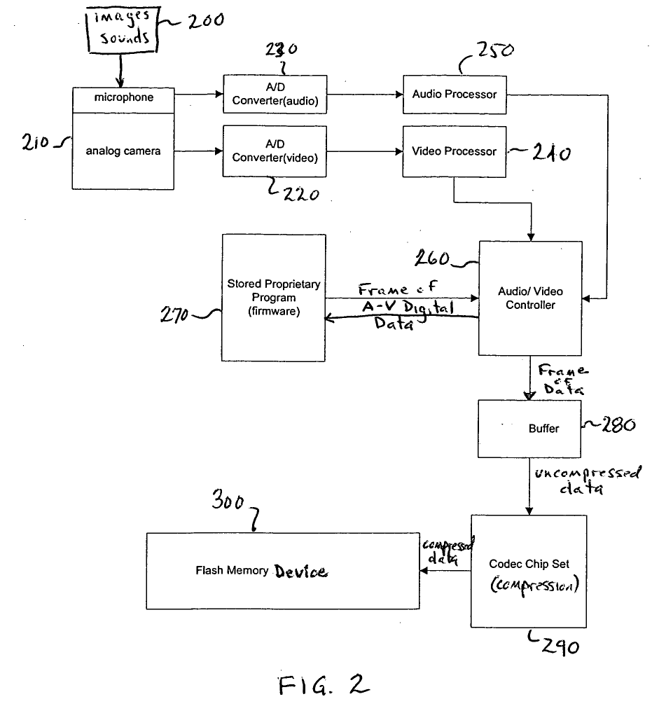

Now referring to FIG. 2 in a preferred embodiment in practice images and sounds in block 200 are received in analog camera and microphone in block 210. The respective analog audio and video signals are converted in analog/digital converters in blocks 220 (video) and 230 (audio), through video processor 240 and audio processor 250 and subsequently transmitted to audio/video controller in block 260 where a frame of audio/video digital data is formed. The frame of data is analyzed in block 270 according to a stored software program, described below, and sent to a buffer in block 280. The uncompressed data is transmitted to a codec chip set in block 290 where it is compressed. The compressed data is transmitted to a flash memory device in block 300.

In a preferred embodiment the buffer in block 280 is a 30 second circular SDRAM buffer capable of storing 900 frames of data. In a preferred embodiment video compression in block 290 in the present invention is maximized using MPEG4 to achieve a 45:1 compression ratio. Other compression means may be employed such as but not limited to DIVX compression achieving 2 MB per minute. Also in a preferred embodiment the flash memory device in block 300 is at least 64 mb and preferably 1024 mb to store up to 250 video captures.

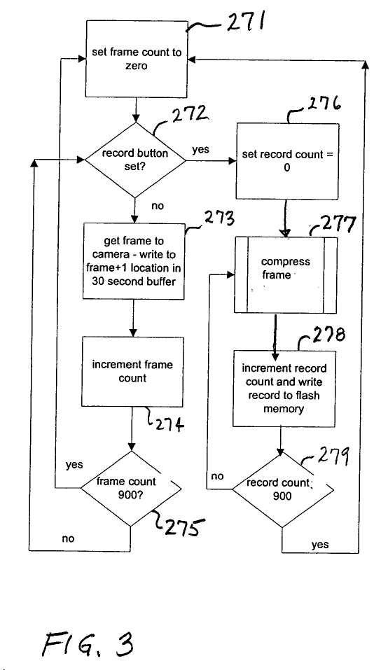

Now referring to FIG. 3, the stored software program applied in block 270 of FIG. 2 is disclosed. In block 271 the frame count is set to zero. In block 272 the algorithms asks if the record button is set. If the record button is not set a frame is obtained from the camera and and written to frame +1 location in the 30 second buffer. Frame count is incremented in block 274. In block 275 if frame count equals 900 the frame count is set to zero in block 271. If the frame count is less than 900 the logic returns to block 272 to determine whether the record button is set.

If the record button is set in block 272 the logic proceeds to block 276 where the record count is set to zero. The frame is then compressed in block 277 via the codec. Record count is incremented and the record count is written to the flash memory in block 278. In block 279 if record count equals 900 the frame count is set to zero in block 271. If the record count is less than 900 the next frame is compressed in block 277.

In a most preferred embodiment a device according to the present invention is provided that automatically switches from a monitoring mode wherein the last 30 seconds or so “seen” or monitored by the camera can be and is captured to memory, to a direct real time record mode if no further action is taken by the user, e.g., a “stop” button is pressed. When activated, the proprietary software enables the camera to continuously monitor what the camera wearer is seeing. In order to permanently record audio and video, the user presses a record button and triggers the software to save the previous 30 seconds of monitored video and audio to flash memory. If no stop command is given the camera can continue recording in real time.

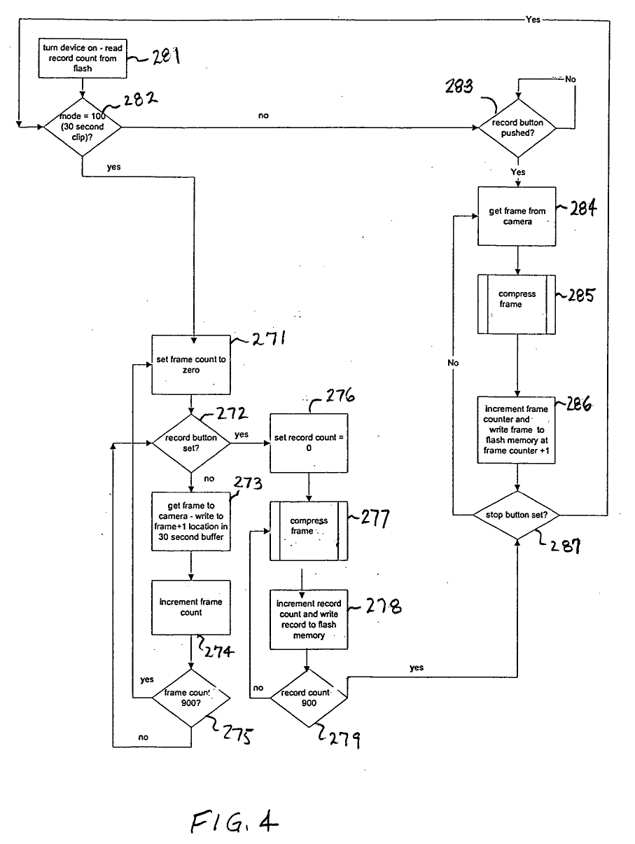

Now referring to FIG. 4, an algorithm performed in accordance with this embodiment is preferably as follows:

The device is turned on in block 281 and the record count is read from flash memory. The logic then determines in block 282 whether mode=100 30 second clips; if yes, then the frame count is set to zero in block 271 and the logic proceeds accordingly as set forth hereinabove with respect to FIG. 3 until block 279 is reached, after which the logic set forth in FIG. 4 applies as set forth below. If not, the logic determines whether the record button is pushed in block 283; if the record button is not pushed the logic continues to examine whether the record button is pushed. If the record button is pushed, a frame is obtained from the camera in block 284. The frame is compressed in block 285 and in block 286 the steps of incrementing the frame counter and writing the frame to flash memory at frame counter +1 are carried out. The logic then determines whether the stop button is set in block 287. If the stop button is set, the logic then determines in block 282 whether mode=100 30 second clips and the algorithm proceeds accordingly. If the stop button is not set, the logic proceeds to block 284 and proceeds accordingly.

If the record count in block 279 equals 900 the logic determines in block 287 whether the stop button is set. If not, a frame is obtained from the camera in bock 284, the frame is compressed in block 285 and in block 286 the steps of incrementing the frame counter and writing the frame to flash memory at frame counter +1 are carried out. The logic then determines whether the stop button is set in block 287.

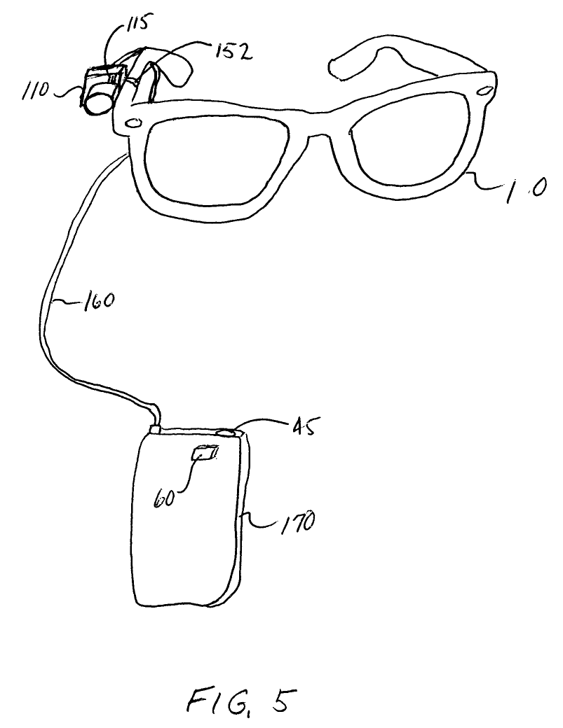

Now referring to FIG. 5 in a preferred embodiment device 2 comprises camera 110 mounted on glasses 150 by attachment means such as but not limited to clip 152 (or to other means such as a cap, hap, hair clip, comb or the like, to be near the eyes of a user to most advantageously permit the device to “see” what it is the user sees) connected via cable 160 to remote unit 170. Camera 110 further comprises microphone 115. Remote unit 170 may comprise an attachment means (not shown) such as a clip for attachment to a belt loop, shirt pocket, backpack or the like. In a preferred embodiment device 2 captures the last 0-30-second or more of what the user of the device 2 just viewed and heard when user presses the appropriate button 60 on the remote unit 170. Device 2 can record multiple 30 second captures based upon the size of the external flash memory 120. In a preferred embodiment the video stored on the removable media is in a format that can be viewed and heard via media players such as Windows Media Player or Real One Media Player. The device in a preferred embodiment provides video quality minimum of 30 frames per second; video quality meets CIF standards with frames at 320×240 pixels. Audio is preferably mono. In a further embodiment device 2 further comprises an indicator light 45 to inform the user when there is insufficient storage left on the compact flash card to store another 0-30-second or more image.

Camera 110 may take any form and may be adapted to be permanently attached to headgear. In addition, camera 110 and remote device may comprise a unitary device 170 that may be attached to any headgear including but not limited to glasses 150.

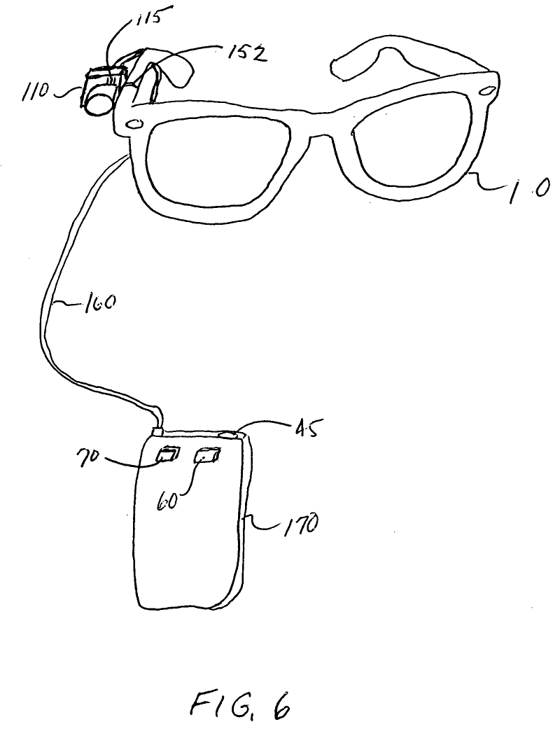

Now referring to FIG. 6 in a most preferred embodiment device 2 comprises camera 110 mounted on glasses 150 connected to remote unit 170 via cable 160. Device 2 comprises record button 60 that when activated causes device 2 to capture the last 0-30-second or more of what the user of the device 2 just viewed and heard. Device 2 further comprises mode button 70. Device 2 is adapted to automatically switch from a monitoring mode wherein the last 30 seconds or so monitored by the camera can be and is captured to memory, to a direct real time record mode if no further action is taken by the user, e.g., mode button 70 is activated. When activated, the proprietary software according to FIG. 4 hereinabove enables the camera to continuously monitor what the camera wearer is seeing. In order to permanently record audio and video, the user activates record button 60 and triggers the software to save the previous 30 seconds of monitored video and audio to flash memory. If mode button 70 is not activated, no stop command is given and the camera continues recording in real time. The invention is preferably adapted to store at least 100 clips of video and audio. In a most preferred embodiment the recording function of the camera is disabled while the camera is capturing and compressing the previous 30 seconds.

While the above describes the preferred embodiment of the invention, various modifications or additions would be apparent to those of skill in the art. For example, further features contemplated herein including but not limited to USB port, NTSC connection port, LCD, external flash memory connector port, further user input buttons and the like as discussed herein are not shown in the drawings merely for the sake of clarity. The preferred embodiments set forth herein are exemplary and the teachings of the present invention are not limited to what is shown in the Figures.

What is claimed is:

1. A device adapted to capture unrecorded images and sounds in memory such that said images and sounds may be saved and played back, said device comprising a camera for receiving said images and sounds, a buffer and a memory means for storing said images and sounds, said buffer storing a given sequence of said images and sounds to be recorded, said device further adapted to provide a monitoring mode.

2. The invention according to claim 1 further comprising a user-activated means for recording buffered images to said media.

3. The invention according to claim 2 said user activated means comprising a record button.

4. The invention according to claim 1 adapted to be attached in the vicinity of the eyes of a user of the device.

5. The invention according to claim 1 said camera comprising an analog camera, said device further comprising a video processor that converts analog signals to digital signals.

6. The invention according to claim 1 further comprising a signal compressor.

7. The invention according to claim 1 further comprising a flash memory.

8. The invention according to claim 1 further comprising at least one of a USB port, NTSC port and an LCD screen.

9. The invention according to claim 1 further comprising a housing for containing components of said device.

10. The invention according to claim 1 wherein said camera is remote from a remainder of said components.

11. The invention according to claim 6 said compressor comprising an MPEG 4 device.

12. The invention according to claim 1 further comprising means to switch the device from a monitoring mode to a direct real time record mode.

13. A device adapted to capture unrecorded data in memory such that said data may be saved and played back, said device comprising a camera for receiving said data, a buffer and a memory means for storing said data, said buffer storing a given sequence of said data to be recorded.

14. The invention according to claim 13 said data comprising analog data representing at least one image.

15. The invention according to claim 13 said data comprising audio data representing at least one sound

16. A system for capturing unrecorded images and sounds in memory such that said images and sounds may be saved and played back comprising
at least one data receiver adapted to provide a monitoring mode;
at least one means for creating at least one frame of digital data from said data received; software for controlling and analyzing said frame of data;
a buffer;
a codec chip set for compressing said at least one frame of data; and
means for transmitting said compressed data to a flash memory.

17. The system according to claim 16 said codec chip set comprising an MPEG 4 device.

18. The system according to claim 16 further comprising a power source.

19. The system according to claim 16 wherein said data receiver is an analog camera and further comprising at least one analog to digital converter.

20. The system according to claim 17 further comprising a microphone.

21. The system according to claim 16 further comprising means to switch the system from a monitoring mode to a direct real time record mode.

22. A method of capturing unrecorded images and sounds in memory such that said images and sounds may be saved and played back comprising the steps of:
providing a data receiver for receiving analog audio and video signals;
converting said analog signals to digital;
forming at least one frame of audio/video digital data;
analyzing said frame of data according to a stored software program;
sending said frame of data to a buffer;
compressing said frame of data; and
storing said compressed data.

23. The method according to claim 22 comprising the further step of providing said data receiver with a monitoring mode.

24. The method according to claim 23 comprising the further step of providing said data receiver with means to switch the receiver from a monitoring mode to a direct real time record mode.

25. The method according to claim 22 comprising compressing said data using an MPEG 4 device.
